(19) United States
(12) Patent Application Publication
(10) Pub. No.: US 2026/0307633 A1
(43) Pub. Date: Oct. 8, 2026

(54) METHOD OF OPERATING AN ANTI-LOCK BRAKING SYSTEM OF A VEHICLE

(71) Applicant: ZF CV Systems Global GmbH, Bern (CH)

(72) Inventors: Robin Szymanski, Hannover (DE); Andreas Marx, Seelze (DE); Hartmut Binder, Hannover (DE)

(21) Appl. No.: 19/480,558

(22) PCT Filed: Apr. 23, 2024
(86) PCT No.: PCT/EP2024/061016

§ 371 Date: Oct. 31, 2025

(30) Foreign Application Priority Data
May 3, 2023 (DE) 10 2023 111 424.7

(51) Int. Cl. B60T 8/1761; B60T 8/18

(52) U.S. Cl. CPC B60T 8/17616; B60T 8/18; B60T 2240/06; B60T 2270/10

(57) ABSTRACT

A method (100) for operating a service brake (210) in relation to an axle (205) of a vehicle (200a), in particular a utility vehicle (200b), in order to brake a wheel (215) of the axle (205) accounts for a change in road conditions. The method includes (100): recording (110) an input variable (260) external to the axle; ascertaining (120) an axle load transfer (270) on the basis of the input variable (260) external to the axle; and outputting (130) a control signal (280) for changing a braking variable (211) of the service brake (211), taking into account the axle load transfer (270).

### FIELD

The present disclosure relates to a method for operating a service brake in relation to an axle of a vehicle, in particular a utility vehicle, in order to brake a wheel of the axle. The present disclosure also relates to a computer program and/or computer-readable medium, a control unit for a vehicle, in particular a utility vehicle, and a vehicle, in particular a utility vehicle.

### BACKGROUND

Braking systems for vehicles are known from the prior art. Such braking systems may comprise a so-called anti-lock braking system (ABS). The braking system is designed to exert a braking torque on a wheel or multiple wheels of the vehicle in order to decelerate the vehicle. The ABS here reduces or prevents the locking of a wheel braked by the braking system by reducing a brake pressure and may therefore improve a braking procedure as well as the driving safety.

ABS are known, which record the wheel speed of the wheel to be braked and, in the event of too abrupt a change in the speed of the wheel, cause a reduction in the brake pressure in order to avoid or end any locking of the wheel.

Furthermore, centrally controlled braking systems are known, which enable a braking force distribution and/or vehicle dynamics control, for example using input signals from a longitudinal acceleration sensor.

DE 10 2018 123 996 A1 discloses an at least two-channel electro-pneumatic central pressure control module, designed as a structural unit, for an electro-pneumatic service brake device of a vehicle, having at least two pressure control channels, which can be electrically controlled with regard to a brake pressure. It is provided here that a central electronic brake control unit has a circuit board which supports electric and electronic components, wherein routines at least for the brake pressure control and for the vehicle dynamics control are implemented in the electric and electronic components, wherein at least one inertial sensor is arranged on or in the at least one circuit board and is connected in an electrically conductive manner to at least some of the electronic and electronic components on the circuit board such that the output signals of the at least one inertial sensor can be fed into the at least some electric and electronic components for the purpose of carrying out the vehicle dynamics control. Optionally, ABS pressure control valves may be connected between the central pressure control module as a “central module” and brake cylinders at wheels of a first axle and a second axle, which ABS pressure control valves enable the brake pressure in these brake cylinders to be controlled in a wheel-specific manner.

The ABS pressure control valves here are controlled by the central electronic brake control unit. An anti-lock braking system of a wheel of an axle according to the prior art controls the braking of the wheel on the basis of information which relates to the wheel and/or the axle itself, possibly influenced by an input signal of the central control unit.

Such control of an ABS, however, may result in a repeated axle load transfer and a corresponding movement of a driver's cab of the vehicle, in particular with certain friction properties of the roadway or ground and particular vehicle configurations.

The ABS here may excite a vibration mode of the vehicle through a repeated axle load transfer. The vibration mode here may result in a repeated, for example periodic, shift in the axle load. This may be unpleasant for a driver and/or occupants of the vehicle. Moreover, a normal force acting between the wheels and the ground changes repeatedly.

An axle load shift during braking with an ABS may result in a significant loss of traction, i.e. a comparatively abrupt and significant slip at one or more wheels, owing to a periodically rising and falling normal force on the wheels of the vehicle or axles of the vehicle.

If the axle load shift is comparatively great, this may cause pressure control devices to be too slow to reduce a brake pressure in a brake chamber such that the locking of one or more wheels may be prevented.

Furthermore, it can be observed that, for example, ABS pressure control valves are subject to increasingly high demands in terms of cost-effectiveness. In this regard, an improvement to the control of an ABS may compensate the repercussions of such demands and/or nevertheless improve the effect of the ABS.

### SUMMARY

The present disclosure is therefore based on the object of enhancing the prior art. One embodiment achieves the object of attaining improved operation of a service brake in the event of an axle load shift in order to prevent too great a slip at a wheel of the vehicle and/or a rocking of the vehicle, where possible.

Said object is achieved by a method according to the subject matters according to the present disclosure.

According to an aspect of the present disclosure, a method for operating a service brake in relation to an axle of a vehicle, in particular a utility vehicle, in order to brake a wheel of the axle is proposed. The method comprises: recording an input variable external to the axle; ascertaining an axle load transfer on the basis of the input variable external to the axle; and outputting a control signal for changing a braking variable of the service brake, taking into account the axle load transfer.

The vehicle, in particular a utility vehicle, is referred to below as vehicle. The method is therefore a method for controlling the service brake, in particular an anti-lock braking system (ABS), of the vehicle. To this end, the input variable external to the axle is recorded. The input variable external to the axle here may be a variable relating to the vehicle, but not or not solely to the axle having the wheel to be braked, and/or a variable relating to a further axle of the vehicle. The input variable external to the axle may be recorded via a sensor and/or via communication technology, for example via a vehicle bus and/or via an interface for communication outside the vehicle. The input variable may comprise a plurality of different pieces of information which enable the ascertainment of the axle load transfer. Comprehensive characterization for variables which are potentially relevant for braking is thus possible.

The axle load transfer may be ascertained on the basis of the input variable. The axle load transfer here is a variable with which a shift in the weight of the vehicle to different axles of the vehicle can be quantified relative to an idle position, for example with an axle load transfer of zero. The axle load transfer may result, for example, from an excitation of a vibration mode of the vehicle due to an ABS. It has been recognized here that the axle load transfer has an influence on the normal force acting between the wheel and the ground. If the weight of the vehicle shifts in the direction of the axle or if the axle load is transferred in the direction of the axle, the normal force typically rises, which may prevent locking of the wheel. If the weight of the vehicle shifts away from the axle or if the axle load is transferred away from the axle, the normal force typically drops, which may promote locking of the wheel. It has therefore been recognized that the axle load transfer is a suitable, quantifiable and effectively ascertainable variable which may have an influence on the control of the service brake in order to improve the braking.

Taking into account the axle load transfer, the control signal for changing the braking variable of the service brake may be output. As a result of the control signal, a predictable change in the axle load transfer may be brought about and/or a repeated axle load transfer caused by the excitation of a vibration mode of the vehicle may be avoided. As a result of the targeted change to the braking variable, too great a slip of the wheel may be avoided here. Furthermore, the excitation of vibration modes and also of a movement of the cab may be suppressed and/or prevented. The braking variable here may be a variable determining the braking torque of the wheel and/or the wheels of the axle which may be applied to the service brake as a result of the control signal.

The present disclosure provides an approach which enables the wheel and/or the axle to be controlled by the service brake depending on information, data or variables which, as such, are not dependent, or are only indirectly dependent, on the braking of the wheel and/or the axle.

The method may be applied in a wheel-specific manner here, i.e. to only one wheel of the axle. Alternatively or in addition, the method may be applied to multiple wheels of the axle and/or for multiple wheels of an axle package comprising multiple axles.

Optionally, the ascertainment of the axle load transfer takes place on the basis of a change in a normal force acting on a wheel of a further axle. It has been recognized here that the total normal force acting on all wheels of all axles typically fluctuates little, whereas, as a result of the excitation of a vibration mode of the vehicle, for example, the normal force acting on one wheel of one of the axles may fluctuate repeatedly or in an alternating manner, i.e. it may rise and drop. Therefore, if the change relates to a rise in the normal force acting on the wheel of the further axle, for example, it may be inferred that there is a drop in the force acting on the wheel of the axle, and vice versa. The normal force acting on the further wheel of the further axle may therefore provide information relating to a possible change in the normal force on the wheel of the axle that is to be braked, which may therefore imply a change to the braking variable.

Optionally, the input variable external to the axle comprises a normal force acting on a wheel of a further axle and/or an axle load of the further axle. The normal force acting on the wheel of the further axle may be compared with a mean value and may provide information relating to the axle load transfer, for example taking into account further variables such as road gradient. To this end, the input variable external to the axle alternatively or additionally comprises a slip and/or a wheel speed of the wheel of the further axle. The time development of the wheel speed and/or the slip may be recorded and evaluated. Alternatively or in addition, a time derivation of the wheel speed and/or the slip may be ascertained. Alternatively or in addition, the input variable external to the axle comprises a longitudinal acceleration relating to the vehicle. The longitudinal acceleration may provide information relating to the deceleration of the vehicle, from which an expected axle load transfer may be inferred. Alternatively or in addition, the input variable external to the axle comprises a braking variable relating to the braking of the wheel of the further axle. The braking variable may be, for example, a brake pressure, a braking force and/or a braking torque. On the basis of the braking variable, it is possible to infer a setpoint reaction of a wheel, for example with an ordinary axle load distribution, which may be compared with an actual reaction, possibly under the influence of the axle load transfer, in order to estimate the axle load transfer. Alternatively or in addition, the input variable external to the axle comprises a road gradient to enable the road gradient, where applicable, to be taken into account as an offset in the event of an axle load transfer.

Optionally, a prediction of the axle load transfer is ascertained for outputting the control signal. It has been recognized here that, as a result of the inertia of the vehicle under the influence of the chassis, the transfer of the axle load is subject to characteristic dynamics. The axle load transfer therefore takes place with a characteristic time scale and is therefore predictable. In particular, as a result of the excitation of a vibration mode of the vehicle, a typical sequence of axle load transfers occurs. As a result of predicting the axle load transfer, a change to the braking variable may be effected promptly in order to enable the dynamics of the service brake to be taken into account.

Optionally, the control signal is output such that the braking variable is increased if a rise in a normal force between the wheel and the ground is predicted. It has been recognized here that an expected increase in the normal force makes heavier braking possible. Optionally, the control signal is output such that the braking variable is lowered if a drop in a normal force between the wheel and the ground is predicted, in order to avoid locking or too weak braking in the event of an expected reduction in the normal force.

Optionally, the ascertainment of the axle load transfer takes place on the basis of a numerical vehicle model. It has been recognized here that the numerical model may define parameters which are relevant for braking and which relate to the vehicle. The parameters may relate, for example, to dynamics of the chassis and/or the service brake. The axle load transfer may be effectively ascertained taking into account sensor measurements as inputs into the numerical vehicle model.

According to one aspect of the present disclosure, a computer program and/or a computer-readable medium is provided. The computer program and/or the computer-readable medium comprises/comprise commands which, when the program or the commands is or are executed by a computer, cause the latter to carry out the method according to the present disclosure and/or steps of said method. Optionally, the computer program and/or the computer-readable medium comprises/comprise commands which, when the program or the commands is or are executed by a computer, cause the latter to carry out the method steps described as being advantageous or optional, in order to achieve a technical effect associated therewith.

According to one aspect of the present disclosure, a control unit for a vehicle, in particular a utility vehicle, is provided. The control unit here is designed to carry out the method described above. Optionally, the control unit is designed to carry out the method such that one or more of the features described as optional above are realized in order to achieve an associated technical effect.

According to one aspect of the present disclosure, a vehicle, in particular a utility vehicle, comprising a service brake with an anti-lock braking system and the control unit described above, is provided. The control unit here may have one or more features described as optional in order to achieve an associated technical effect.

### BRIEF DESCRIPTION OF THE DRAWINGS

Further advantages and features of the present disclosure as well as the technical effects thereof are revealed in the figures and the description of the preferred embodiments shown in the figures. In the figures:

FIG. 1 shows a schematic illustration of a vehicle, in particular a utility vehicle, according to one embodiment of the present disclosure; and

FIG. 2 shows a schematic illustration of a flow chart of a method according to one embodiment of the present disclosure.

### DETAILED DESCRIPTION

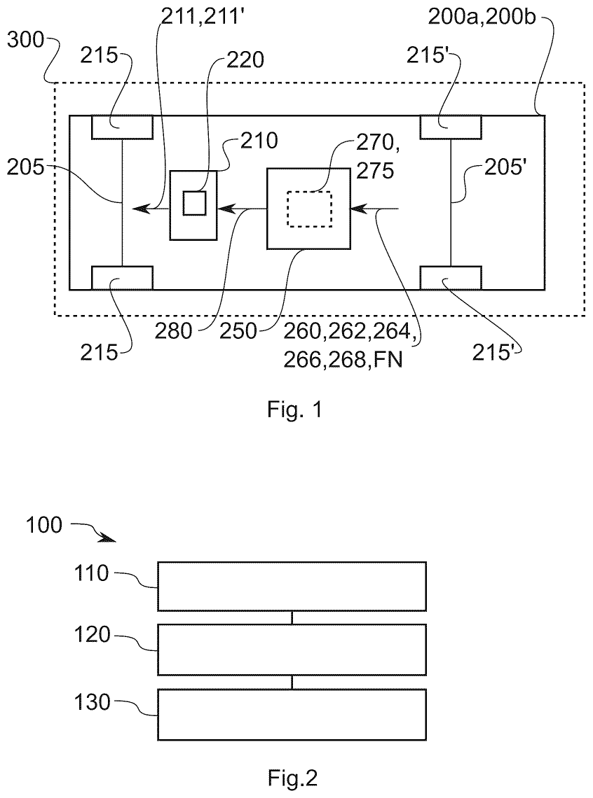

FIG. 1 shows a schematic illustration of a vehicle 200a, in particular a utility vehicle 200b, of one embodiment of the present disclosure.

The vehicle 200a, in particular the utility vehicle 200b, is referred to below as vehicle 200a, 200b. The vehicle 200a, 200b is a land vehicle, for example a traction engine of a multi-unit utility vehicle.

The vehicle 200a, 200b is positioned on the ground 300 in an environment. The ground 300 is, for example, a roadway with possibly locally varying features. The features of the ground 300 have an influence on a friction value and therefore the driving dynamics of the vehicle 200a, 200b and, in particular, the braking of the vehicle 200a, 200b.

The vehicle 200a, 200b includes multiple axles 205, 205′, for example two axles 205, 205′. The vehicle 200a, 200b includes a plurality of wheels 215, 215′ associated with the axles 205, 205′, for example two wheels 215, 215′ for each axle 205, 205′. In an embodiment which is not shown, the vehicle 200a, 200b has more than two axles 205, 205′ and/or the vehicle 200a, 200b has more than two, for example four, wheels 215, 215′ on at least one of the axles 205, 205′.

The vehicle 200a, 200b is positioned with the wheels 215, 215′ on the ground 300. That is to say the wheels 215, 215′ are in contact with the ground 300. The wheels 215, 215′ and the ground 300 are in operative contact with one another along a contact surface. A friction value, which characterizes the contact between the respective wheel 215, 215′ and the ground 300, can be defined at the contact surface between the wheels 215, 215′ and the ground 300. The friction value may be different for each of the wheels 215, 215′.

As a result of the contact between the wheels 215, 215′ and the ground 300, a normal force FN acts between the wheels 215, 215′ and the ground 300. The normal force FN here is the force acting perpendicularly to the contact surface between the respective wheel 215, 215′ and the ground 300. In the case of a horizontally aligned roadway as the ground 300 and an idle vehicle 200a, 200b, the normal force FN may act, for example, in a vertical direction. The ground 300 may have a road gradient 264, i.e. the roadway as the ground 300 may have an upward and/or downward slope. The vehicle 200a, 200b has force sensors (not shown), which ascertain the normal force FN and/or a difference between a normal force FN in the idle position of the vehicle 200a, 200b and the normal force FN present. The force sensors may measure, for example, a force associated with a deflection of a component of a chassis of the vehicle 200a, 200b.

The vehicle 200a, 200b includes a service brake 210. The service brake 210 is a pneumatic, hydraulic and/or electro-mechanical brake. The service brake 210 is designed to achieve a braking effect for braking the vehicle 200a, 200b. To this end, the service brake 210 is designed to slow a movement of the wheels 215, 215′, or to control the slowing of the movement of the wheels 215, 215′. The service brake 220 may apply a braking variable 211, 211′, for example a braking torque, a braking force and/or a brake pressure, in order to decelerate the wheel(s) 215, 215′.

The service brake 210 includes an anti-lock braking system 220. The anti-lock braking system 220 is designed to detect a locking tendency of the wheels 215, 215′ and to prevent locking of the wheels 215, 215′ and/or to reduce the locking tendency of the wheels 215, 215′. To this end, the anti-lock braking system 220 is designed to intervene in the braking and to reduce the braking variable 211 if, for example, a locking tendency is identified and/or to increase the braking variable 211 if a locking tendency is not present.

A longitudinal acceleration 262, a wheel speed 268 at the wheels 215, 215′ and a slip 266 are established as a result of the vehicle 200a, 200b being driven and/or braked. The longitudinal acceleration 262 describes the movement of the vehicle 200a, 200b in its main movement direction and can be measured, for example, by an acceleration sensor. The wheel speed 268 of one of the wheels 215, 215′ can be measured by a wheel speed sensor. The wheel speed 268 may be different for each of the wheels 215, 215′. The slip 266 can be ascertained, for example, on the basis of the wheel speed 269 and a reference speed.

An axle load transfer 270 may take place as a result of the vehicle 200a, 200b being braked. With this, the vehicle 200a, 200b may tilt. For example, the vehicle 200a, 200b initially tilts forwards when braking. The chassis of the vehicle 200a, 200b is deflected forwards and rebounds rearwards here. With this, the normal force FN on the wheels 215 of the axle 205 designed as a front axle rises and the normal force FN on the wheels 215′ of the further axle 205′ designed as a rear axle drops. If the deceleration decreases, for example if there is a reduction in the braking variable 211, the chassis of the vehicle 200a, 200b is deflected rearwards and rebounds forwards. With this, the normal force FN on the wheels 215 of the axle 205 designed as a front axle drops and the normal force FN on the wheels 215′ of the further axle 205′ designed as a rear axle rises.

The vehicle 200a, 200b includes a control unit 250. The control unit 250 is designed to carry out the method 100 described with reference to FIG. 2.

The control unit 250 is designed to record an input variable 260 external to the axle. To this end, the control unit 250 is connected to a force sensor on the axle 205′ for the purpose of measuring the normal force FN acting on the wheel 215′ of the further axle 205′ and/or the axle load as an input variable 260. To measure and/or ascertain the wheel speed 268 and/or the slip 266 of the wheel 215′ of the further axle 205′ as an input variable 260, the control unit 250 is connected to a wheel speed sensor of the further axle 205′. To measure the longitudinal acceleration 262 as an input variable 260, the control unit 250 is connected to an acceleration sensor. The control unit 250 is designed to retrieve the road gradient 264 as topographical map information and/or to ascertain the road gradient via distance measurement and triangulation, for example using LiDAR. The control unit 250 may alternatively or additionally be designed to request the above-mentioned input variables 260 from a vehicle bus, for example a CAN bus.

The control unit 250 is designed to ascertain the axle load transfer 270 on the basis of the input variable 260 external to the axle. One or more of the input variables described above are evaluated here. In particular, a time progression of the described input variables 260 may be evaluated here. In particular, a time derivation of the input variables 260 may be evaluated to establish whether the respective input variable 260 rises or drops. The axle load transfer 270 is ascertained, in particular, on the basis of a change in the normal force FN acting on the wheel 215′ of the further axle 205′. The normal force FN acting on the wheel 215′ of the further axle 205′ is an indicator of the deflection or rebound of the vehicle 200a, 200b at the further axle 205′. The change in the normal force FN of the further axle 205′ therefore reflects the dynamics of the axle load transfer 270. The control unit 250 is designed to evaluate a numerical vehicle model 275. The control unit 250 here may use the input variable 260 as an input and calculate the axle load transfer 270 dynamically.

The control unit 250 is designed to output a control signal 280 to the service brake 210 in order to change the braking variable 211 of the service brake 210 and the axle load transfer 270. A prediction of the axle load transfer 270 is ascertained here for outputting the control signal 280. The control signal 280 is output such that the braking variable 211 is increased if a rise in a normal force FN between the wheel 215 and the ground 300 is predicted. The control signal 280 is output such that the braking variable 211 is lowered if a drop in a normal force FN between the wheel 215 and the ground 300 is predicted. The control signal 280 is output such that a change to the braking variable 211 takes place alternatively or in addition to an ABS control by the anti-lock braking system 220 or alternately therewith.

The vehicle 200a, 200b is therefore designed to reduce and/or avoid possible negative effects of an axle load transfer 270. A significant axle load transfer 270 may cause an abrupt loss of traction of a wheel 215, 215′, i.e. an undesirably high increase in the slip 266, for example due to a drop in the normal force FN acting on the wheel 215. If the axle load transfer 270 is too great, a braking system according to the prior art might not provide the required pressure decrease quickly enough and might therefore further reinforce the axle load transfer 270. The vehicle 200a, 200b according to FIG. 1 is designed to maintain or reduce the braking variable 211 for the front axle 205 if the further wheel 215′ of the further axle 205′, i.e. the rear axle, decelerates. Therefore, in the event of a subsequent axle load transfer 270 to the rear, a loss of traction of the wheel 215 of the front axle 205 may be counteracted. Alternatively or in addition, the control unit 250 is designed to calculate a model for the axle load transfer 270, to predict the axle load transfer 270 and to change the braking variable 211 according to a prediction of the axle load transfer 270.

FIG. 2 shows a schematic illustration of flow chart of a method 100 according to one embodiment of the present disclosure. The method 100 is a method 100 for operating a service brake 210 in relation to an axle 205 of a vehicle 200a, in particular a utility vehicle 200b, in order to brake a wheel 215 of the axle 205. Such a vehicle 200a, 200b is described with reference to FIG. 1. FIG. 2 is described with reference to FIG. 1.

According to FIG. 2, the method 100 includes: recording 110 an input variable 260 external to the axle. The input variable 260 external to the axle includes a normal force FN acting on a wheel 215′ of a further axle 205′, an axle load of the further axle 205′, a slip 266 of the wheel 215′ of the further axle 205′, a wheel speed 268 of the wheel 215′ of the further axle 205′, a longitudinal acceleration 262 relating to the vehicle 200a, 200b, a braking variable 211′ relating to the braking of the wheel 215′ of the further axle 205′, and/or a road gradient 264.

The method 100 includes: ascertaining 120 an axle load transfer 270 on the basis of the input variable 260 external to the axle. The ascertainment 120 of the axle load transfer 270 takes place on the basis of a change in a normal force FN acting on a wheel 215′ of a further axle 205′. The ascertainment 120 of the axle load transfer 270 takes place on the basis of a numerical vehicle model 275.

The method 100 includes: outputting 130 a control signal 280 for changing a braking variable 211 of the service brake 211, taking into account the axle load transfer 270. A prediction of the axle load transfer 270 is ascertained for outputting 130 the control signal 280. The control signal 280 is output such that the braking variable 211 is increased if a rise in a normal force FN between the wheel 215 and the ground 300 is predicted. The control signal 280 is output such that the braking variable 211 is lowered if a drop in a normal force FN between the wheel 215 and the ground 300 is predicted.

### REFERENCE SIGNS (PART OF THE DESCRIPTION)

100 Method
110 Record
120 Ascertain
130 Output
200a Vehicle
200b Utility vehicle
201 Centre of gravity
205, 205′ Axle
210 Service brake
211, 211′ Braking variable
215, 215′ Wheel
220 Anti-lock braking system
250 Control unit
260 Input variable external to the axle
262 Longitudinal acceleration
264 Road gradient
266 Slip
268 Wheel speed
270 Axle load transfer
275 Vehicle model
280 Control signal
300 Ground
FN Normal force

1. A method (100) for operating a service brake (210) in relation to an axle (205) of a vehicle (200a), in order to brake a wheel (215) of the axle (205), wherein the method (100) comprises:
recording (110) an input variable (260) external to the axle;
ascertaining (120) an axle load transfer (270) on the basis of the input variable (260) external to the axle; and
outputting (130) a control signal (280) for changing a braking variable (211) of the service brake (211), taking into account the axle load transfer (270).

2. The method (100) as claimed in claim 1, wherein the ascertaining (120) of the axle load transfer (270) takes place on the basis of a change in a normal force (FN) acting on a wheel (215′) of a further axle (205′).

3. The method (100) as claimed in claim 1, wherein the input variable (260) external to the axle comprises a normal force (FN) acting on a wheel (215′) of a further axle (205′), an axle load of the further axle (205′), a slip (266) of the wheel (215′) of the further axle (205′), a wheel speed (268) of the wheel (215′) of the further axle (205′), a longitudinal acceleration (262) relating to the vehicle (200a), a braking variable (211′) relating to the braking of the wheel (215′) of the further axle (205′), and/or a road gradient (264).

4. The method (100) as claimed in claim 1, wherein a prediction of the axle load transfer (270) is ascertained for outputting (130) the control signal (280).

5. The method (100) as claimed in claim 4, wherein the control signal (280) is output such that the braking variable (211) is increased if a rise in a normal force (FN) between the wheel (215) and the ground (300) is predicted.

6. The method (100) as claimed in claim 4, wherein the control signal (280) is output such that the braking variable (211) is lowered if a drop in a normal force (FN) between the wheel (215) and the ground (300) is predicted.

7. The method (100) as claimed in claim 1, wherein the ascertaining (120) of the axle load transfer (270) takes place on the basis of a numerical vehicle model (275).

8. A non-transitory computer-readable medium, comprising commands which, when the commands are executed by a computer, cause the computer to carry out the method (100) as claimed in claim 1.

9. A control unit (250) for a vehicle (200a), wherein the control unit (250) is designed to carry out the method (100) as claimed in claim 1.

10. A vehicle (200a), comprising a service brake (210) having an anti-lock braking system (220) and the control unit (250) as claimed in claim 9.

11. The method of claim 2, wherein the axle is a rear axle and the further axle is a front axle.

12. The method of claim 7, wherein the numerical model defines parameters that are relevant for braking and that relate to the vehicle.

13. The method of claim 12, wherein the parameters relate to dynamics of a chassis and/or the service brake of the vehicle.

14. The method of claim 1, wherein the axle load transfer results from an excitation of a vibration mode of the vehicle due to anti-lock braking.

15. The method of claim 2, wherein the normal force rises when a vehicle weight shifts toward the axle, and wherein the normal force drops when the vehicle weight shifts away from the axle.

16. The method of claim 2, wherein the normal force fluctuates.

17. The method of claim 2, wherein the normal force is compared to mean value.

18. The method of claim 1, wherein the vehicle includes an anti-lock braking system.
